(19) United States
(12) Patent Application Publication
(10) Pub. No.: US 2004/0033904 A1
(43) Pub. Date: Feb. 19, 2004

(54) Textured metal article

(76) Inventors: Joanne Camilla Moore, Oxford (GB); Christopher Richard Munro Grovenor, Oxford (GB); Russell Goodall, South Wales (GB); Richard Melville Whiteley, Surrey (GB)

Correspondence Address: NIXON & VANDERHYE, PC, 1100 N GLEBE ROAD, 8TH FLOOR, ARLINGTON, VA, 22201-4714, US

(21) Appl. No.: 10/258,737

(22) PCT Filed: Apr. 20, 2001
(86) PCT No.: PCT/GB01/01793

(30) Foreign Application Priority Data
Apr. 28, 2000 (GB) 0010494.3

(51) Int. Cl. H01B 1/00

(52) U.S. Cl. 505/100

(57) ABSTRACT

A process for producing a metal article coated with a metal layer having a biaxially textured surface, which process comprises eletctrodepositing the metal layer on a biaxially textured metal substrate such that the surface of the metal layer has the same texture as that of the substrate.

This invention relates to biaxially textured metal articles.

There has been a considerable amount of research into the production of wires and other articles from high temperature ceramic superconductors. It is now accepted that very few types of grain boundary between crystals can support the high currents required by many applications of superconductors. In practice, this means that it is desirable to make large areas or long lengths of tape where all the superconducting grains are in a single orientation and so simulate a single crystal. One way of doing this is by making superconductors as single crystals or in essentially single-crystal form in the form of epitaxial films on single crystal or biaxially textured substrates. It is commonly found that a biaxial texture is necessary to obtain high transport critical current densities.

A typical method for producing such a superconducting material is to make a textured substrate from a metal such as nickel or a nickel alloy. The substrate is textured by rolling and recrystallising. The crystallographic orientation or texture of the substrate is then used as a template onto which one or usually two or more barrier/buffer layers of metal and then the superconductor are deposited in order, retaining the texture of the metal substrate. The barrier layers are for example metals and oxides or just oxides. The buffer layer can be deposited by a number of methods typically including vacuum deposition methods, e.g. sputtering, evaporation or dip-coating of solutions or gels. Once the buffer layer(s) have been deposited, the article is subjected to a heat treatment in order to impart the texture to the buffer layers. The superconductor, for example YBaCuO, is then deposited on the buffer layer(s).

Generally buffer layers such as silver or oxides such as CeO₂ are deposited on the substrate using vacuum techniques such as sputtering. Typically an additional buffer layer of another metal such as palladium or platinum is deposited on the substrate prior to depositing the silver or oxide buffer layer in order to reduce the lattice mismatch between silver and the substrate.

A typical superconductor with a noble metal buffer layer comprises a typically 50-150 μm thick nickel (or alloy) substrate coated with 20 to 2000 nm of sputtered palladium or platinum. This is coated with a typically 100 nm to 25 μm thick coating of silver or silver oxide. This is optionally coated with a third buffer layer of a material such as CeO₂, MgO or YSZ (yttria-stabilised zirconia). The substrate and its coatings is generally subjected to a heat treatment step during deposition of the layers in order to cause the coatings to develop the texture of the substrate. The superconducting layer is then deposited on the textured silver surface.

A ceramic buffer layer may be used in the production of a superconductor. Examples of ceramic buffer layers are YSZ, MgO, TiN, ZrO₂, CeO₂, LaAlO₃ and SrTiO₃. These are suitably deposited by techniques such as vacuum coating or sol-gel on the metal coated substrate. The superconductor layer is then deposited on the ceramic buffer layer.

Another process typically uses a nickel or nickel alloy substrate coated with a 10 to 100 nm thick layer of CeO₂. The buffer layer of CeO₂ is generally covered with a 50 to 1000 nm thick layer of YSZ or Yb₂O₃. A third buffer layer of for example CeO₂, Yb₂O₃ or LaAlO₃ may also be used. A YBCO superconductor layer is then typically deposited on the combination of buffer layers for example by pulsed laser deposition or BaF₂ precursor co-evaporation. Other suitable superconductors include NdBCO, and Tl, Bi1223. This process may also be used with a platinum-palladium substrate.

Other suitable buffer layers include Yb₂O₃, Gd₂O₃, NiO, NdAlO₃ and LaAlO₃. These are generally used on a pure nickel substrate between the substrate and a superconducting layer of for example YBCO.

It is necessary to have the coating layers between the metal substrate, which is typically nickel or copper, and the superconducting layer, for example YBaCuO, because nickel and copper and other suitable substrate materials usually react with the superconducting layer. It is therefore necessary to separate the superconducting layer and the substrate by a buffer layer.

An object of the present invention is to provide a new process for producing biaxially textured metal coated metal articles. A further object of the invention is to use the biaxially textured coated metal articles as substrates in the production of superconducting articles. In particular this invention seeks to provide a process for coating a metal substrate with a silver buffer coating suitable for further coating with a superconducting layer. In the process of the invention a thin layer of metal is provided on a suitable substrate. The metal is electrodeposited on the substrate forming a thin layer that maintains the texture of the substrate. The invention forms a textured bi-layer or laminate structure where each layer is distinct i.e. there is substantially no diffusion of atoms from one layer into the other layer. Thus the crystallographic texture of the deposited layer follows faithfully that of the substrate.

Accordingly, the present invention provides a process for producing a metal article coated with a metal layer having a biaxially textured surface, which process comprises electrodepositing a metal layer on a biaxially textured metal substrate such that the surface of the metal layer has the same texture as that of the substrate.

The present invention further provides a biaxially textured metal coated article comprising:

(a) a metal substrate; and

(b) an electrodeposited metal layer on the substrate, wherein the surface of the metal layer has the same texture as that of the substrate

The metal substrate comprises any metal which can form a suitable texture. Examples include single metals and metal alloys. The substrate is typically made by roiling a metal or alloy which is generally obtained for example as a rod or sheet. Suitable metals or alloys include copper, nickel and alloys thereof, for example NiCr or NiFe. Rolling the metal or alloy forms it into a suitable article which is, for example, a tape or wire. During the rolling process, plastic flow causes reorientation of the lattice of individual grains of the substrate and the substrate tends to develop a preferred orientation of the grains (the texture). The resulting article is then typically heated so as to change the crystallographic orientation of the grains. This provides a surface with a useful recrystallisation texture.

Electrodeposition is used to deposit a metal or a mixture of metals to form a textured metal surface. For example Cr, Ni, Pd, Pt, Ru, Os, Rh, Ir, Au or Cu or mixtures thereof or silver may be electrodeposited by this method. Typically silver or a silver alloy is used. Silver or a silver alloy is particularly useful as an intermediate layer between a metal substrate, for example nickel, and a superconducting layer. Suitable silver alloys include for example alloys of silver with one or more of In, Fe, Pb, Mn, Hg, Mo, Ni, Pd, Pt, Rh. Sc. Se, Au, Te, Sn, Ti, V, W, Zn, Ga, Cu, Co, Cr, Cd, As or Sb.

Electrodeposition can be used to deposit metals or alloys, such as those listed above, in turn to form a substrate with two or more metal layers. In one embodiment an oxygen barrier layer such as Ru, Os, Rh, Ir, Pd. Pt or Au or a mixture thereof, is deposited on the metal substrate. However, any suitable combination of metal layers may be used. Each layer may be deposited using separate baths or two layers may be plated from one bath to simplify the process.

In order to deposit more than one layer from a single plating bath, a plating bath containing all the metals to be deposited can be used. The metals should be present with compatible solution chemistries. Typically, deposition of the different metals is achieved by controlling the plating conditions, for example by controlling the current density (galvanostatic control) or the cathode potential (potentiostatic control) during the plating process, generally by pulsing the potential.

The present invention is particularly suitable for depositing a buffer layer on a substrate. The process of the present invention has the advantage that the amount of metal used to form the buffer layer can be much reduced. Further, the metal develops the biaxial texture of the substrate on deposition on the substrate and it is therefore not necessary to treat the coated substrate by heating it in order to develop the texture. It is a further advantage of the present invention that lattice mismatches of the type which occur in existing processes are generally compensated for in the electrodeposition of the metal buffer layer, thereby removing the need for additional buffer layers of other materials such as palladium or platinum. The nickel/silver structures of the present invention have the further advantage that the structure is thermally stable (up to 900° C.). In contrast, structures using an intervening palladium layer suffer from Pd/Ag alloying during subsequent heat treatment and/or superconductor deposition.

The present invention is also suitable for depositing multiple metal layers on a metal substrate. In particular, one or more intermediate metal layers may be desirable to further overcome a lattice mismatch or to act as an oxygen barrier layer. For example, when a thin layer of silver is deposited directly on a nickel substrate, oxygen can diffuse through the silver coating and react with the nickel to form nickel oxide. This can cause dewetting of the silver coating from the substrate. Depositing an intermediate oxygen barrier layer, for example a layer of ruthenium, osmium, rhodium, iridium, palladium, platinum or gold, preferably rhodium, can eliminate this problem. An intermediate rhodium layer between a nickel substrate and a silver layer, for example also reduces lattice strain in the silver layer as rhodium has a lattice parameter between that of silver and nickel. Other intermediate layer metals with appropriate lattice parameters can also be used to reduce lattice strain.

An oxygen barrier layer is typically deposited as an intermediate layer. For example, an oxygen barrier such as rhodium is probably not as chemically compatible with a superconductor as a metal layer such as silver. Therefore a further metal layer, such as silver, is typically deposited over the oxygen barrier layer. However, in one preferred embodiment of the invention a single oxygen barrier metal layer is deposited on the metal substrate.

Thus, the present invention also provides a process which further comprises electrodepositing one or more further metal layers sequentially on the metal coated substrate, such that the or each resulting metal layer has the same surface texture as that of the substrate.

The present invention also provides an article which further comprises one or more metal layers sequentially electrodeposited over the electrodeposited metal layer (b) and wherein the surface of each metal layer has the same texture as that of the substrate.

Overall, the process is typically reduced by several stages.

The electrodeposited layer is generally epitaxial and is coherent giving greater than 95% coverage of the substrate.

The present invention also has the advantage that the production of a suitably textured metal layer such as cube textured silver is easier and more reproducible. The final composite structure obtained by the process of the present invention is also more robust than pure silver. This is important in the fabrication and operation of any device using the final article.

Electrodeposition techniques also have the advantage that simple equipment is used and the technique is easily scalable for industrial use. In a typical embodiment the substrate is advanced through an electroplating bath at a current density and speed such that the desired coating thickness is achieved. Further the technique can be performed at room temperature and atmospheric pressure which is an advantage compared to, for example, vacuum techniques.

In one aspect the process of the present invention as defined above further comprises the step of coating the, or the top, metal layer with a superconducting layer. In another aspect the process includes the step of polishing or electropolishing the metal substrate before deposition of the metal layer.

The substrate is rolled using forward rolling only or using reverse rolling (the rolling direction is reversed after each pass). It is generally found that reverse rolling produces better results. The rolling speed generally influences the texture development. However, its effect does not normally dominate the result achieved and higher rolling speeds are generally desirable for economic reasons. The substrate may be rolled by hand. Typically a hand-rolled substrate is rolled occasionally reversing the tape between passes. During the rolling process a lubricant is optionally employed depending on the texture required. Where a lubricant is employed it is for example a light mineral oil, a heavy mineral oil, kerosene or another lubricant known for this purpose. In general, a fine grain size is desirable in the material before rolling and initial heat treatments and deformations are usually designed so as to give a random texture in the starting material before rolling.

The substrate is typically textured by annealing. Where appropriate a substrate is rolled and annealed alternately in order to produce a suitable texture. A substrate is typically rolled to achieve a certain percentage deformation and then annealed. Typically a deformation of above 90% is suitable. A suitable deformation for copper is typically 95 to 97% and a suitable deformation for nickel is typically about 93%.

The temperature for rolling the substrate varies according to the material of the substrate and the texture that is to be produced, as one of skill in the art will be aware. Copper rods are suitably rolled at room temperature in order to produce for example, a sharp cube texture, which is developed after annealing. Cube texture can also be achieved in alloys based on silver, copper, nickel or iron. Annealing temperatures are generally at least 50° C., for example 500 to 800° C. However, higher annealing temperatures are frequently chosen. For example annealing temperatures of up to 1200° C. are common. The annealing temperature will be selected for the particular metal. Thus, as an extreme example silver can recrystallise slowly at room temperature. Copper and nickel can be annealed, for example, in vacuum or in a mixture of argon and hydrogen. Copper is typically annealed at a temperature of from 200-1000° C. for a few seconds to an hour, for example, copper is suitably annealed in vacuum at 500 to 800° C. for 1 hour. Nickel is typically annealed at a temperature of from 200 to 1200° C. for a few seconds to four hours, for example nickel is suitably annealed in an argon/hydrogen mixture comprising 4% hydrogen at about 800° C. for 4 hours.

Suitable textures for substrates include {100} <100>, {100} <110>, {110} <100>and {110} <110 >. For example {100}<100> texture is typically obtained on copper or nickel substrates, in particular copper or nickel tape. The cube and hexagonal textures are often preferred, in particular the cube texture.

The thickness of the deposited metal layer depends on the metal deposited and on the proposed application for the coated substrate. Typically the metal layer has a thickness of from 1 run to 10 μm. A silver layer electrodeposited on the substrate generally has a thickness of up to 10 μm, preferably from 0.01 to 2 μm, more preferably from 0.01 to 1 μm, for instance 0.05 to 0.5 μm, and most preferably about 0.1 to 0.2 μm. A rhodium layer generally has a thickness of from 1 nm to 10 μm, for instance 10 nm to 1 μm, preferably 10 nm to 250 nm.

A metal layer of such thickness develops the texture of the substrate on deposition on the substrate. Preferably the metal layer is deposited epitaxially on the substrate. Generally the conditions of the electroplating bath are chosen so as to optimise the development of the texture of the metal layer.

Electrodeposition is generally carried out at a temperature of from 10 to 95° C. The current density is typically from 1 to 50000 A/m². Plating times are generally from 10 μs to 1 hour and the electrodeposition generally takes place at atmospheric pressure.

Electrodeposition of silver is suitably carried out at a temperature of from 10 to 95° C., more preferably 10 to 90° C., for instance 20 to 90° C., more preferably 20 to 85° C. Electrodeposition is generally conducted at atmospheric pressure. The current density used is as high as possible, generally in the range 50 to 50000 A/m², preferably 50 to 25000 A/m² and most preferably 50 to 1000 A/m². The plating time is typically from 10 μs to 1 hour, for instance 10 seconds to 30 minutes, preferably 1 to 10 minutes, depending to an extent on the amount of current used and on the desired thickness. In addition, very fast electrodeposition processes are particularly preferred, for example with a plating time of 10 μs to 1 μs preferably 10 ms to 500 ms.

Rhodium is typically electrodeposited at a temperature of from 10 to 80° C., preferably 10 to 70° C., for instance 15 to 60° C., more preferably 20 to 50° C. The current density used is typically in the range of from 1 to 10000 A/m². The plating time is typically from 10 μs to 1 hour, for instance 10 seconds to 30 minutes, preferably 1 to 10 minutes, depending to an extent on the current density and the desired thickness.

Once electrodeposition has taken place the texture can be studied by x-ray diffraction to confirm the texture formed.

Electrodeposition takes place in any suitable solution in order to electrodeposit the metal layer on the substrate. Such solutions will be familiar to those with knowledge of electrodeposition. A suitable plating solution typically contains a salt or oxide of the metal to be deposited, generally with a conducting salt and typically also a complex-forming agent.

A variety of silver plating solutions are known. Although solutions containing cyanide are the most common when electrodepositing silver, non-toxic solutions can also be used. Examples of silver plating solutions include hydantoin based, cyanide based, thiosulphate based and succinimide based solutions

When electrodepositing silver compounds from non-cyanide solutions the silver salt used is generally silver nitrate, silver oxide or a mixture thereof. Silver may also be used in the form of silver thiosulphate or potassium silver disuccinimide or in the form of KAg(CN) in cyanide based solutions. The silver salt is generally used in combination with a conducting salt and also a complex-forming agent. The complex-forming agent may be a hydantoin compound. Suitable hydantoin compounds include 1-methylhydantoin, 1,3-dimethylhydantoin, 5,5-dimethylhydantoin, 1-methanol-5,5-dimethylhydantoin and 5,5-diphenylhydantoin. The conductive salt is typically sodium chloride, potassium chloride, potassium formate or a mixture thereof. Generally the silver is present in the bath in an amount of from 1 to 100 g/l, preferably 5 to 50 g/l, more preferably 8 to 30 g/l as metal concentration. The complex-forming agent is generally present in an amount of from 10⁻¹⁵ to 10⁻² mol/litre, preferably 10⁻¹⁰ to 10⁻³ mol/l and the conductive salt is generally present in an amount of from 1 to 100 g/l, preferably 5 to 50 g/l, more preferably 10 to 25 g/l.

An example of a hydantoin based silver plating composition is silver nitrate as the silver salt, potassium chloride as the conducting salt and hydantoin as the complex-forming agent in distilled water. This composition is typically used with a pure silver anode.

An example of a cyanide based silver plating solution is silver as KAg(CN), potassium cyanide and potassium carbonate. This solution may be used containing for example 1 to 40 g/l KAg(CN), 10 to 140 g/l free potassium cyanide and 15 g/l potassium carbonate. A suitable temperature for such solutions is, for example. 20 to 30° C. The current density used for electroplating is, for example, 50 to 400 A/m².

Another suitable cyanide based solution, known as a high speed silver solution, is a cyanide based solution comprising silver as KAg(CN) and conducting/buffering salts. Such a solution typically contains 20 to 80 g/l of silver as KAg(CN) and 60 to 120 g/l of conducting/buffering salts. A high speed silver solution is generally operated at a pH of from 8 to 9.5, a temperature of from 60 to 70° C. and a current density of from 3000 to 38,000 A/m². The solution is typically agitated rapidly while electrodeposition occurs. A suitable anode for this solution is platinum or a platinum/titanium mixture.

A suitable thiosulphate plating solution comprises, for example, silver thiosulphate, sodium thiosulphate and sodium metabisulphite. Typically such a solution contains about 30 g/l of silver as thiosulphate, 300 to 500 g/l of sodium thiosulphate and 30 to 50 g/l of sodium metabisulphite. The solution is generally used at a pH of from 8 to 10, a temperature of from 15 to 30° C. and a current density of from 40 to 100 A/m².

A suitable succinimide solution comprises potassium silver disuccinimide, succinimide and potassium sulphate. Typically the solution contains about 30 g/l of silver as potassium silver disuccinimide, 11 to 55 g/l of succinimide and about 45 g/l of potassium sulphate. The solution is generally used at a pH of about 8.5, a temperature of 15 to 30° C. and a current density of 40 to 100 A/m².

Rhodium is typically electrodeposited using a rhodium sulphate solution in the presence of sulphuric acid. The solution is generally used at a pH of 2 or less preferably pH 1 or less, a temperature of 15 to 50° C. and a current density of 5 A/m². Other known rhodium plating solutions may also be used.

The electrodeposition operates at a pH chosen according to the plating chemistry used. The pH for silver deposition is, for example, from 3 to 13, preferably 5 to 11, most preferably 6 to 10. A pH of 6 to 8 is preferred for a hydantoin based solution and a pH of 9 to 10 is preferred for a cyanide based solution. A pH of 2 or less is generally used for rhodium.

A particularly preferred procedure is to electrodeposit a silver layer on a nickel or nickel alloy substrate. Other preferred procedures include depositing a rhodium layer, or a rhodium layer and then a silver layer, on a copper or nickel substrate.

The metal substrate is generally electropolished before the metal layer is electrodeposited on the substrate. However, electropolishing is not always necessary. The use of an intermediate metal layer may remove the need for electropolishing the substrate. In particular, a very acidic plating bath may remove any residual oxide from the surface of the textured metal substrate. Any conventional electropolishing technique known in the art may be used. For example a solution of phosphoric acid or sulphuric acid may be appropriate. Typical electropolishing times range from 5 seconds to 10 minutes at a current density of about 5000 A/m². A suitable electropolishing technique will be chosen having regard to the metal substrate being used; suitable techniques will be known by those skilled in the art. For example copper frequently does not need to be electropolished. However, if desired, copper can be electropolished using phosphoric acid, for example 70% phosphoric acid for from 5 to 60 seconds at a current density of 5000 A/m². Nickel and nickel alloys are generally electropolished using sulphuric acid. Typically nickel is electropolished using a solution of 4H₂SO_{4.}3H₂O for about 3.5 minutes at 6000 A/m². A Ni—10Cr alloy is typically suitably electropolished for 10 minutes at 6000 A/m² in 4H₂SO_{4.}3H₂O. A nickel-30Fe alloy is typically suitably electropolished in 4H₂SO_{4.}3H₂O for 5 minutes at 6000 A/m².

The coated substrate can then be coated with a superconducting layer. Suitable superconductors include superconductors from the Re—Ba—Cu—O (Re denotes a rare earth element), Tl—(Pb, Bi)—Sr—(Ba)—Ca—Cu—O and Hg—(Pb)—Sr—(Ba)—Ca—Cu—O families. A typical superconductor for deposition on the metal layer is YBaCuO. NdBCO and Tl, Bi 1223 are also commonly used. MgB₂ may also be used. The superconductor is deposited on the metal layer by any suitable method known in the art, for example sputtering, pulsed laser deposition, BaF₂ precursor coevaporation, e-beam evaporation, MOCVD, liquid phase epitaxy, spray pyrolysis, sol-gel or electrodeposition.

In one embodiment the metal coated substrate is coated with a ceramic buffer layer or superconducting layer and then one or more farther metal layers are electrodeposited on top. The ceramic layer may be a single crystal or a textured layer. Thus a multilayer structure comprising metal and ceramic or superconducting layers is built up. The final deposited layer is a metal layer. In a particular embodiment the substrate is coated in order by one or more metal layers, a ceramic layer, one or more metal layers, a ceramic buffer layer or superconducting layer and a final metal layer.

The invention is further illustrated by the following examples:

### EXAMPLES

### Example 1

A 99.98% pure sample of oxygen-free high-conductivity copper with a thickness of 2 mm was obtained. The copper was rolled to achieve 95% deformation and then annealed at 700° C. for 1 hour in order for texture to develop. The copper substrate was then polished using a 70% phosphoric acid solution in water and a current density of 5000 A/m² for 1 minute.

A metal layer of silver was electrodeposited on the copper substrate using a plating bath with the following composition:

| | |
|---|---|
| AgNO₃ | 8 g/l |
| KCl | 16 g/l |
| hydantoin | 40 g/l |

which was made up to concentration using distilled water. The electrodeposition took place at 57° C. using a current density of 500 A/m² for 15 minutes. The anode was made of pure silver. The pH of the bath started at 6 and rose to pH 7 during the electrodeposition process.

The texture of the deposited silver layer was confirmed by x-ray diffraction.

### Example 2

A sample of pure nickel was rolled to achieve 93% deformation and then annealed at 800° C. for 4 hours to allow the texture to develop. The nickel substrate was electropolished using 4H₂SO_{4.}3H₂O in an electropolishing bath for 3.5 minutes at a current density of 6000 A/m².

A metal layer of silver was then deposited on the nickel substrate using the plating bath composition of Example 1.

Electrodeposition was carried out for 15 minutes at a current density of 500 A/m² and a temperature of 53° C. The pH of the bath was pH 7 throughout the deposition practice. The anode was pure silver.

The texture of the metal layer was confirmed by x-ray diffraction.

### Example 3

A 99.98% pure sample of oxygen-free high-conductivity copper was obtained with a thickness of 2 mm. The copper sample was rolled to achieve 95% deformation. The sample was then annealed at 500° C. for 1 hour in order for the texture to develop.

A metal layer of silver was then electrodeposited on the copper sample without electropolishing the copper sample. The electrodeposition bath had the same composition as in Example 1.

The electrodeposition process was carried out for 30 minutes at a temperature of 80° C. The pH of the bath started at pH 6 and rose to pH 7 during the deposition process. The anode was pure silver.

The texture of the metal layer was confirmed by x-ray diffraction.

### Example 4

A 90% nickel-10% chromium alloy sample was rolled to achieve 97.5% deformation. The sample was then annealed to 1000° C. for 4 hours to allow the texture to form. The nickel/chromium alloy was electropolished using 4H₂SO_{4.}3H₂O electropolishing bath. Electropolishing was carried out for 10 minutes at a current density of 6000 A/m².

The nickel-chromium alloy was electrodeposited with a silver layer using an electrodeposition bath with a composition as in Example 1.

Electrodeposition was carried out at 65° C. for 10 minutes at a current density of 500 A/m². The pH of the electrodeposition bath remained at pH 7 throughout the deposition process. The anode was made of pure silver.

The texture of the silver layer was confirmed by x-ray diffraction.

### Example 5

A 99.98% pure sample of oxygen-free high-conductivity copper with a thickness of 2 mm was obtained. The copper was rolled to achieve 97% deformation and then annealed at 800° C. for 1 hour in order for texture to develop. The copper substrate was then polished using a 70% phosphoric acid solution in water and a current density of 20000 A/m² for 20 seconds.

A metal layer of rhodium was electrodeposited on the copper substrate using a plating bath with the following composition:

| | |
|---|---|
| Rhodium (as Rh₂(SO₄)₃.12H₂O) | 2 g/l |
| H₂SO₄ | 20 m/l |

the solution was made up using Johnson Matthey RH8 rhodium sulphate plating solution concentrate (8 g Rh/100 ml) and de-ionised water. The electrodeposition took place at a current density of 50 A/m² for 50 seconds. The anode was made of platinized titanium.

The texture of the deposited rhodium layer was confirmed by x-ray diffraction.

### Example 6

A 99.99% pure nickel rod of 5 mm diameter was rolled to achieve 93% deformation and then annealed at 800° C. in a mixture of argon and 4% hydrogen for 4 hours to allow the texture to develop. The nickel substrate was electropolished using 4H₂SO_{4.}3H₂O in an electropolishing bath for 4 minutes at a current density of 6000 A/m².

A metal layer of rhodium was then deposited on the nickel substrate using the plating bath composition of Example 5.

Electrodeposition was carried out for 8 minutes at a current density of 5 A/m². The anode was platinized titanium.

The texture of the metal layer was confirmed by x-ray diffraction.

### Example 7

A 99.99% pure nickel rod of 5 mm diameter was rolled to achieve 93% deformation and then annealed at 800° C. in a mixture of argon and 4% hydrogen for 4 hours to allow the texture to develop. The nickel substrate was electropolished using 4H₂SO_{4.}3H₂O in an electropolishing bath for 4 minutes at a current density of 6000 A/m².

A metal layer of rhodium was then deposited on the nickel substrate using the plating bath composition of Example 5. The electrodeposition took place at 20° C. and pH 1.

Electrodeposition was carried out for 5 minutes at a current density of 5 A/m². The anode was platinized titanium.

A metal layer of silver was then deposited on the rhodium layer using the plating bath composition of Example 1.

The electrodeposition took place at 20° C. for 30 seconds using a current density of 500 A/m² at pH 10. The anode was pure silver.

The texture of the silver layer was confirmed by x-ray diffraction.

### Example 8

A 99.98% pure sample of oxygen-free high-conductivity copper with a thickness of 2 mm was obtained. The copper was rolled to achieve 97% deformation and then annealed at 800° C. for 1 hour in order for texture to develop. The copper substrate was then polished using a 70% phosphoric acid solution in water and a current density of 20000 A/m² for 20 seconds.

A metal layer of rhodium was electrodeposited on the copper substrate using a plating bath with the following composition:

| | |
|---|---|
| Rh₂(SO₄)₃.12H₂O | 2 g/l |
| H₂SO₄ | 20 m/l |

the solution was made up using Johnson Matthey RH8 rhodium sulphate plating solution concentrate (8 g Rh/100 ml) and de-ionised water. The electrodeposition took place at a current density of 50 A/m² for 1 minute at 20° C. and pH 1. The anode was made of platinized titanium.

A metal layer of silver was electrodeposited on the rhodium layer using a plating bath with the following composition:

| | |
|---|---|
| Ag₂SO₄ | 30 g/l |
| 25% NH₄OH | 75 g/l |
| KI | 600 g/l |
| Na₄P₂O₇ | 60 g/l |

which was made up to concentration using distilled water. The electrodeposition took place using a current density of 100 A/m² for 30 seconds at 20° C. and pH 10. The anode was made of pure silver.

The texture was confirmed by x-ray diffraction.

1. A process for producing a metal article coated with a metal layer having a biaxially textured surface, which process comprises electrodepositing the metal layer on a biaxially textured metal substrate such that the surface of the metal layer has the same texture as that of the substrate.

2. A process according to claim 1 wherein the metal layer is an oxygen barrier layer.

3. A process according to claim 2 wherein the oxygen barrier layer is chosen from rhodium, osmium, ruthenium, iridium, palladium, platinum and gold.

4. A process according to any one of the preceding claims which further comprises electrodepositing one or more further metal layers sequentially on the metal coated metal article, such that the or each resulting metal layer has the same surface texture as that of the substrate.

5. A process according to claim 1 or 4 wherein the, or the further, metal layer is silver.

6. A process according to any one of the preceding claims wherein no heat treatment is used to obtain the textured surface on the or each metal layer.

7. A process according to any one of the preceding claims wherein the or each metal layer has a thickness of up to 10 μm.

8. A process according to claim 7 wherein the or each metal layer has a thickness of from 0.01 to 1 μm.

9. A process according to any one of the preceding claims wherein the substrate is nickel or a nickel alloy.

10. A process according to any one of the preceding claims wherein the or each electrodeposition takes place at a temperature from 10 to 90° C.

11. A process according to any one of the preceding claims wherein the silver is electrodeposited using a current density of from 50 to 50,000 A/m².

12. A process according to any one of claims 1 to 10 wherein rhodium is electrodeposited using a current density of from 1 to 10000 A/m².

13. A process according to any one of claims 1 to 11 wherein silver is electrodeposited at a pH of from 6 to 10.

14. A process according to any one of claims 1 to 10 or 12 wherein rhodium electrodeposited at a pH of 2 or less.

15. A process according to any one of the preceding claims wherein the or each electrodeposition takes place for from 10 μs to 1 hour.

16. A process according to any one of the preceding claims wherein the metal substrate is electropolished before the metal layer is electrodeposited on it.

17. A process according to any one of the preceding claims which further comprises coating the metal coated metal article with a superconducting or ceramic layer.

18. A process according to claim 17 which further comprises electrodepositing a metal layer on the superconducting or ceramic layer.

19. A biaxially textured metal coated article comprising:
(a) a metal substrate; and
(b) an electrodeposited metal layer on the substrate, wherein the surface of the metal layer has the same texture as that of the substrate.

20. An article according to claim 19 which further comprises one or more metal layers sequentially electrodeposited over the electrodeposited metal layer (b) and wherein the surface of each metal layer has the same texture as that of the substrate.
